(19) United States
(12) Patent Application Publication
(10) Pub. No.: US 2022/0056718 A1
(43) Pub. Date: Feb. 24, 2022

(54) Thermal Regulation Apparatus for Pool Water

(71) Applicant: Ernest Russell Murray, Pendleton, SC (US)

(72) Inventor: Ernest Russell Murray, Pendleton, SC (US)

(21) Appl. No.: 17/410,808

(22) Filed: Aug. 24, 2021

Related U.S. Application Data
(63) Continuation-in-part of application No. 29/747,593, filed on Aug. 24, 2020, now Pat. No. D936179.
(60) Provisional application No. 63/069,348, filed on Aug. 24, 2020.

(51) Int. Cl. E04H 4/12; B05B 15/65; F15D 1/06

(52) U.S. Cl. CPC E04H 4/12; F15D 1/06; B05B 15/65

(57) ABSTRACT

A thermal regulation apparatus for pool water is an apparatus that is used to regulate the overall temperature of a pool in an efficient and cost-effective manner. The apparatus may include a water-jet adapter, a tee tubing connector, a valved spout, a valved drain, and an extension pipe. The water-jet adapter enables the apparatus to be connected to a water return jet and serves as the main water inlet of the apparatus. The tee tubing connector distributes the water inflow from the water-jet adapter to the valved drain and the extension pipe. The extension pipe guides the water inflow towards the valved spout. The valved spout serves as the main outlet for the apparatus and enables the cooling of the water outflow that is diffused back into the pool. The valved drain serves as a secondary outlet for the apparatus and helps control the water flow through the apparatus.

The current application claims a priority to the U.S. provisional patent application Ser. No. 63/069,348 filed on Aug. 24, 2020.

### FIELD OF THE INVENTION

The present invention generally relates to pool accessories and temperature regulation systems. More specifically, the present invention provides a means of redirecting a water stream of a pool to cool the water stream by creating turbulent flow to regulate the temperature of the pool.

### BACKGROUND OF THE INVENTION

Swimming on a hot summer day is one of the best ways to cool off and relax. However, depending on the climate and the ambient temperature, the water temperature in the pool may reach uncomfortable levels. There are various methods available to cool pool water such as running the pool filtration system continuously, even during night hours when the air is generally cooler. This method may be costly depending on the electricity costs of the area, and it also may cause unnecessary wear and tear to the filtration system resulting in potentially costly expenses down the road. Another popular option is to install a reverse-cycle heat pump. The reverse cycle heat pumps rely on a refrigerant to cool the water and maintain a specific temperature of the pool water regardless of the ambient conditions. As with the continuous-pumping method, the reverse-cycle heat pump may be a costly solution for pool owners as operating and maintenance costs accrue.

Another available method of cooling pool water is the installation of a water fountain—by circulating water through the atmosphere, the temperature of the water will decrease as heat is exchanged between the ambient air and the water. However, a possible issue with this method is that integrating a water fountain into existing pools may be difficult due to landscape design, location, and preference. Furthermore, calcium and mineral deposits from the decorative installation may leech into the water. The chemicals commonly used to treat and filter pool water may also negatively impact the materials used in the construction of, for example, the waterfall feature, damaging filtration equipment and pumps. It is further considered that the water features that are primarily decorative may not to provide optimum cooling of a pool, sacrificing function for form and ultimately failing to provide the desired cooling effect.

Therefore, an objective of the present invention is to provide a thermal regulation apparatus for pool water that can help to effectively regulate the overall temperature of a pool without requiring major modification of the pool. Another objective of the present invention is to provide a thermal regulation apparatus for pool water that does not negatively affect the pumping system or the filtration system already installed in the pool. Another objective of the present invention is to provide a thermal regulation apparatus for pool water that can be easily installed on a water jet of the pool or similar artificial bodies of water. Additional features and benefits of the present invention are further discussed in the sections below.

### SUMMARY OF THE INVENTION

The present invention is a thermal regulation apparatus for pool water that enables users to easily regulate the temperature of a pool or similar artificial body of water without greatly modifying it. The present invention is a modular, cost-effective means of cooling pool water which may be easily installed onto any return jet of a pool without the addition of complex equipment. In addition, the present invention does not require electricity to operate and can be manually configured to control the water flow through the present invention. The present invention can be easily installed in a return jet of the pool to redirect the water stream out of the pool for cooling of the water stream. Multiple units of the present invention can also be installed in several return jets of the pool for better pool water regulation.

The present invention may redirect the flow of water at a specific angle and distance to create an evaporative cooling stream of water that is able to reduce the overall temperature of the water. The redirected water stream is cooled by creating turbulent flow that introduces air flow into the redirected water stream. The turbulent flow increases the heat transfer between the agitated water stream and the introduced air flow. Furthermore, a suitably formed end-effector nozzle may be provided to further cool the water stream down by atomizing the turbulent water stream. The cooled water stream is then diffused back into the pool to cool down the overall temperature of the pool.

### BRIEF DESCRIPTION OF THE DRAWINGS

FIG. 1 is a top front perspective view of a first embodiment of the present invention.

FIG. 2 is a top rear perspective view of the first embodiment of the present invention.

FIG. 3 is a side view of the first embodiment of the present invention.

FIG. 4 is a front view of the first embodiment of the present invention.

FIG. 5 is a cross-sectional view taken along line 5-5 in FIG. 4, wherein the water flow through the present invention is shown in dotted arrows.

FIG. 6 is a top front perspective view of a second embodiment of the present invention, wherein the present invention is shown equipped with a swivel joint and an aerating nozzle.

FIG. 7 is a bottom rear perspective view of the second embodiment of the present invention.

FIG. 8 is a side view of the second embodiment of the present invention.

FIG. 9 is a front view of the second embodiment of the present invention.

FIG. 10 is a cross-sectional view taken along line A-A in FIG. 9, wherein the water flow through the present invention is shown in dotted arrows.

FIG. 11 is a cross-sectional view taken along line A-A in FIG. 9, wherein the water flow through the present invention is shown in dotted arrows, and wherein the threaded tubular joints are used to assemble and disassemble the present invention.

### DETAIL DESCRIPTIONS OF THE INVENTION

All illustrations of the drawings are for the purpose of describing selected versions of the present invention and are not intended to limit the scope of the present invention.

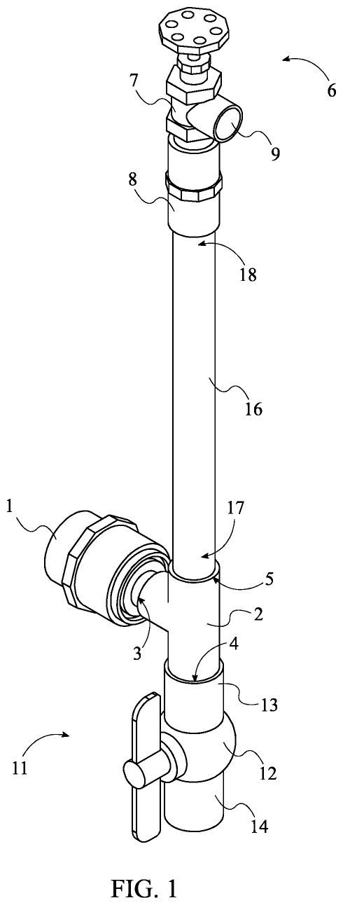

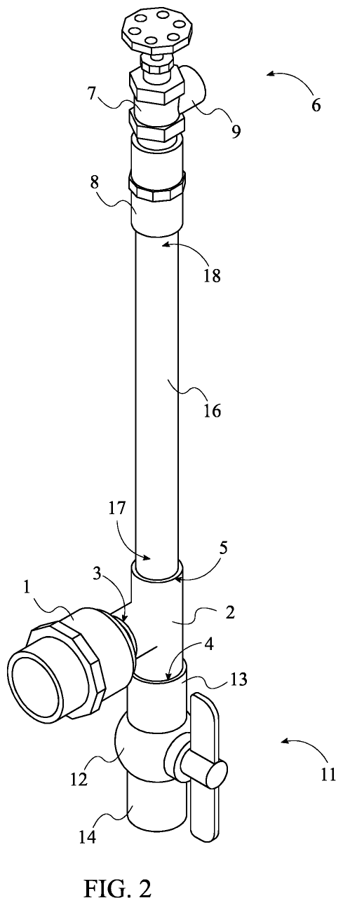

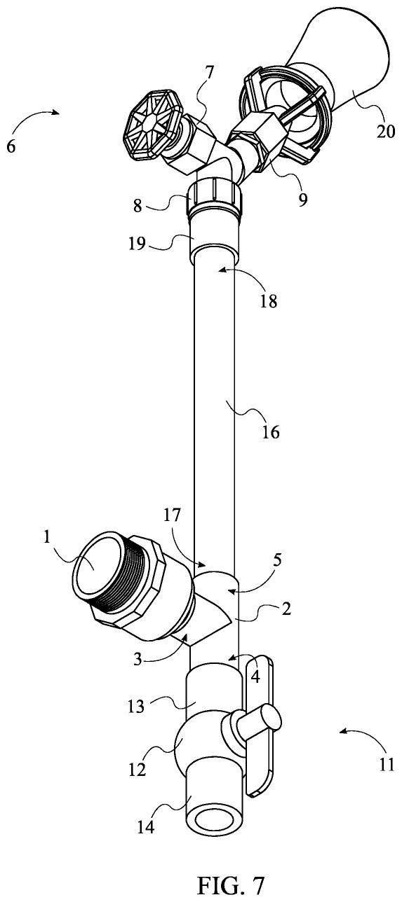

The present invention is a thermal regulation apparatus for pool water that can cool the overall temperature of the pool in an efficient and cost-effective manner. As can be seen in FIGS. 1, 2, 6, and 7, the present invention may comprise a water-jet adapter 1, a tee tubing connector 2, a valved spout 6, a valved drain 11, and an extension pipe 16. The water-jet adapter 1 enables the present invention to be connected to a return jet of the pool. The water-jet adapter 1 also serves as the main inlet of water into the present invention. The tee tubing connector 2 distributes the water inflow from the water-jet adapter 1 to the valved drain 11 and the extension pipe 16. The extension pipe 16 guides the water inflow towards the valved spout 6. The valved spout 6 serves as the main outlet for the present invention. The valved spout 6 also enables the cooling of the water outflow that is diffused back into the pool. The valved drain 11 serves as a secondary outlet for the present invention. The valved drain 11 also helps control the water flow through the present invention.

The general configuration of the present invention allows users to regulate the overall temperature of a pool without consuming additional power or requiring major alterations to the pool. The water-jet adapter 1 is designed to fit in the most common water return jets utilized in pools and similar artificial bodies of water. The water-jet adapter 1 can include multiple gaskets and fittings assembled to fit in the water return jet so that the entire flow of the water stream is redirected into the tee tubing connector 2. The water-jet adapter 1 can also be customized to fit specific designs of water return jets. As can be seen in FIGS. 1, 2, 6, and 7, the tee tubing connector 2 is designed to split the inflow of the water stream from the water-jet adapter 1. So, the tee tubing connector 2 comprises a connector inlet 3, a first connector outlet 4, and a second connector outlet 5. The connector inlet 3 enables the water inflow from the water-jet adapter 1 into the tee tubing connector 2. The first connector outlet 4 and the second connector outlet 5 enable the water outflow from the tee tubing connector 2 into the corresponding fitting. The extension pipe 16 is preferably an elongated conduit that offsets the valved spout 6 so that the valved spout 6 is preferably positioned above the pool water.

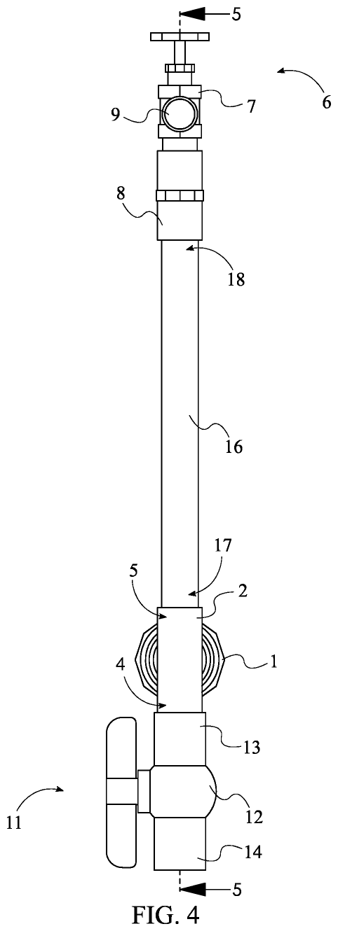

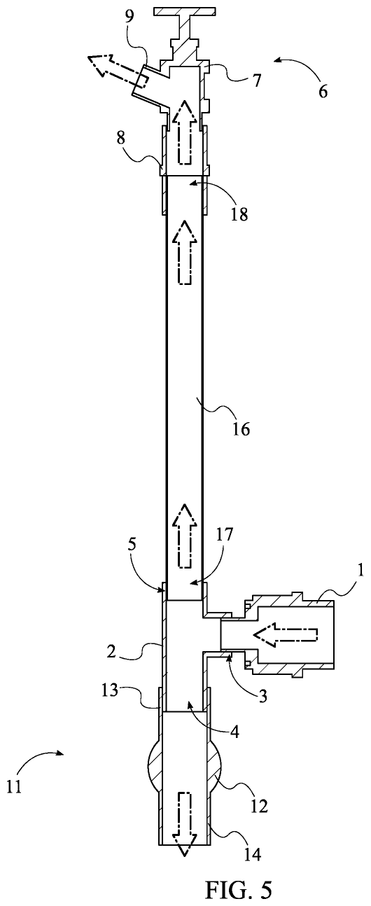

Accordingly, the extension pipe 16 comprises a first pipe end 17 and a second pipe end 18 corresponding to the ends of the elongated extension pipe 16, as shown in FIG. 1 through 5. Moreover, the water-jet adapter 1 is in fluid communication with the connector inlet 3 to enable water inflow from the return water jet of the pool to the tee tubing connector 2 without any leakage to prevent loss in water pressure. The first connector outlet 4 is in fluid communication with the valved drain 11 to enable some of the water outflow from the tee tubing connector 2 to flow back into the pool. The second connector outlet 5 is in fluid communication with the first pipe end 17 to guide the rest of the water outflow from the tee tubing connector 2 to the valved spout 6. Finally, the second pipe end 18 is in fluid communication with the valved spout 6 to cool the water outflow before being diffused back into the pool.

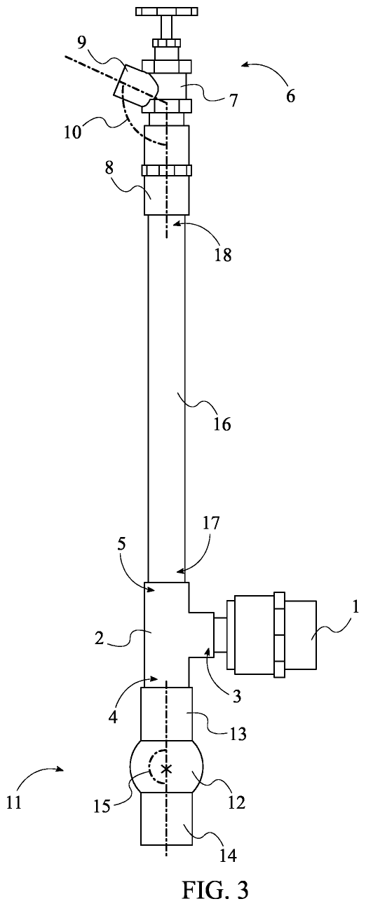

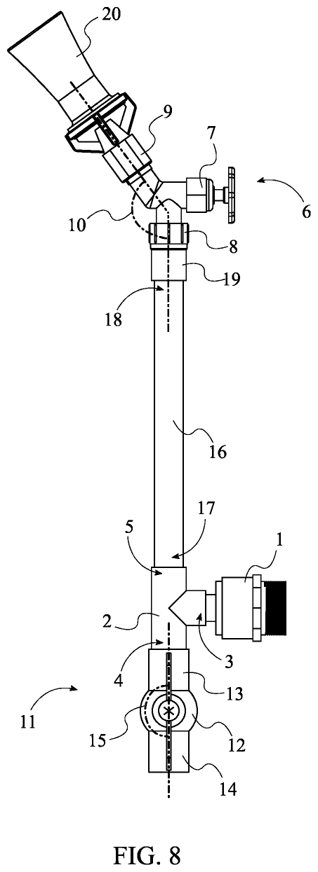

The valved spout 6 is designed so that the user can control the flow rate through the valved spout 6 as well as to control the direction of the water outflow. As can be seen in FIG. 1 through 5, the valved spout 6 may comprise a spout body 7, a spout inlet 8, and a spout outlet 9. The spout body 7 facilitates the cooling of the water before being diffused back into the pool. The spout body 7 also has an integrated valve to enable the manual regulation of the flow rate through the spout body 7. The spout inlet 8 is in fluid communication with the spout outlet 9 through the spout body 7 so that the water flows from the spout inlet 8 to the spout outlet 9. The spout inlet 8 is hermetically connected to the second pipe end 18 to enable the water inflow from the extension pipe 16 into the spout body 7. The spout outlet 9 enables the controlled outflow of the cooled water from the spout body 7 back into the pool. Further, the spout outlet 9 is oriented at a dispensing angle 10 with the spout inlet 8 so that the diffused water outflow is dispensed vertically towards the pool, as shown in FIGS. 3 and 8. In some embodiments, the dispensing angle 10 is an obtuse angle so that water outflow follows a parabolic trajectory before reaching the pool. This greatly increases the heat transfer between the water outflow and the environment to further cool the water outflow, which in turn greatly lowers the overall pool temperature.

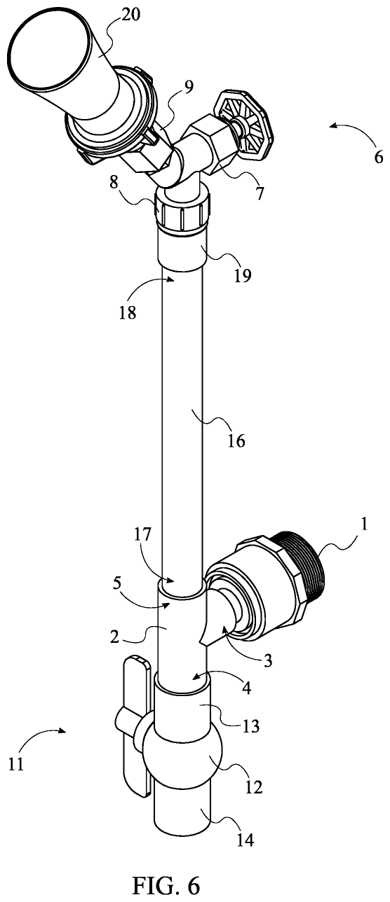

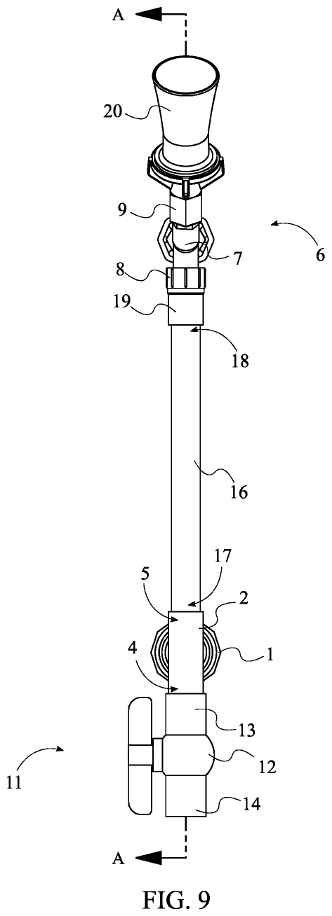

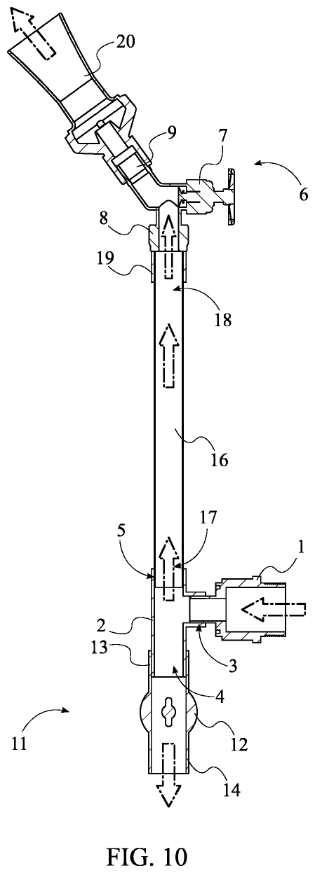

To enable the cooling of the water outflow through the valved spout 6, the present invention may further comprise an aerating nozzle 20. As can be seen in FIG. 6 through 10, the aerating nozzle 20 enables the mixing of the water outflow with airflow to create a turbulent flow of the mixed fluid to cool the water outflow. In addition, the present invention may further comprise a swivel joint 19 to further facilitate the control of the direction of the water outflow out of the spout outlet 9. The spout inlet 8 may be hermetically connected to the second pipe end 18 by the swivel joint 19 so that the whole valved spout 6 can be pivoted towards the desired direction. The spout outlet 9 may also be oriented at a dispensing angle 10 with the spout inlet 8 to facilitate the diffusing of the cooled water in a projectile trajectory, as shown in FIGS. 3 and 8. Further, the aerating nozzle 20 is hermetically connected to the spout outlet 9 so that the whole water outflow passes through the aerating nozzle 20. In some embodiments, the dispensing angle 10 is an obtuse angle to facilitate the projectile trajectory of the water outflow. Further, the aerating nozzle 20 may be a venturi eductor designed to enable the introduction of airflow into the water outflow to create the turbulent flow. This way, the heat transfer between the airflow and the water outflow is increased, which in turn further cools the water outflow. In other embodiments, the valved spout 6 can utilize different cooling mechanisms that do not require power nor utilize chemicals to facilitate the heat transfer between the water flow and the surroundings.

In some embodiments, the venturi eductor may include a first eductor portion, preferably a jet nozzle, connected to the spout outlet 9 to accelerate the water outflow from the spout outlet 9. As can be seen in FIG. 6 through 10, the venturi eductor may also include a second eductor portion, preferably a diffuser, that facilitates the creation of the turbulent flow within the aerating nozzle 20. The second eductor portion may include several air inlets distributed about the inlet of the second eductor portion, adjacent to the first eductor portion, to enable air inflow into the second eductor portion. The inflow of air into the second eductor portion helps with the creation of turbulent flow and with the cooling of the water outflow within the aerating nozzle 20. In addition, the outlet of the second eductor portion may be equipped with an atomizer that helps diffuse the water outflow. Further, the present invention may include different outlet attachments that change the pattern of the water outflow from the spout outlet 9. The user can switch the outlet attachments as desired.

Similar to the valved spout 6, the valved drain 11 is designed to facilitate the control of the water flow rate through the valved drain 11. This enables the user to control how much of the water stream is redirected to the valved spout 6. So, as can be seen in FIGS. 1, 2, 6, and 7, the valved drain 11 may comprise a drain body 12, a drain inlet 13, and a drain outlet 14. Like the spout body 7, the drain body 12 enables the control of the flow rate through the valved drain 11 by using an integrated valve to control how much water is drained before reaching the valved spout 6. The drain inlet 13 is in fluid communication with the drain outlet 14 through the drain body 12 so that the water stream flows from the drain inlet 13 to the drain outlet 14. The drain inlet 13 is hermetically connected to the first connector outlet 4 to enable the water flow from the tee tubing connector 2 to the valved drain 11. Further, the drain outlet 14 is oriented at a drainage angle 15 with the drain inlet 13 that guides the water outflow back into the pool, as shown in FIGS. 3 and 8. In some embodiments, the drainage angle 15 is a straight angle so that the water outflow is oriented downwards back into the pool without creating turbulence in the pool.

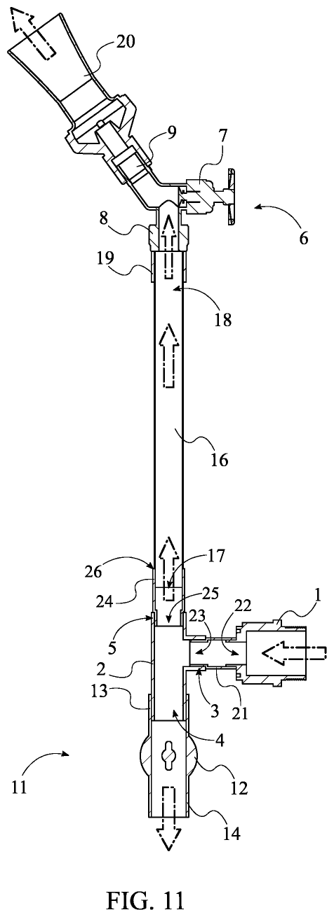

As can be seen in FIG. 11, the present invention may further comprise an inlet tubular joint 21 and an outlet tubular joint 24, which are used to readily assemble or readily dissemble the present invention into its major components. Thus, the inlet tubular joint 21 comprises a first joint end 22 and a second joint end 23, which are opposing open ends of the inlet tubular joint 21. The water-jet adapter 1 is threadably engaged to the first joint end 22, which provides a hermetic connection for water to flow from the water-jet adapter 1 and into the inlet tubular joint 21. The second joint end 23 is threadably engaged to the connector inlet 3, which provides another hermetic connection for water to flow from the inlet tubular joint 21 into the tee tubing connector 2. In addition, the outlet tubular joint 24 comprises a third joint end 25 and a fourth joint end 26, which are opposing open ends of the outlet tubular joint 24. The second connector outlet 5 is threadably engaged to the third joint end 25, which provides another hermetic connection for water to flow from the tee tubing connector and into the outlet tubular joint 24. The fourth joint end 26 is threadably engaged to the first pipe end 17, which provides another hermetic connection for water to flow from the outlet tubular joint 24 into the extension pipe 16.

In an exemplary embodiment, the present invention can be installed in the water return jet of the desired pool. The user may first remove any fittings currently installed in the target water return jet. Then, the user may connect the present invention to the target water return jet using the water-jet adapter 1. After the water-jet adapter 1 has been secured to the target water return jet, the user orients the extension pipe 16 vertically so that the valved spout 6 is positioned above the pool water. After the pool's filtration system has been activated, the user can control the flow rate through the present invention by using the valved spout 6 and/or the valved drain 11. The user can control the water flow rate through the valved spout 6 and the valved drain 11 using the corresponding valves. Further, the user can control the water outflow pressure by opening or closing the valved drain 11. Moreover, the user can reorient the water outflow from the valved spout 6 by pivoting the spout body 7 about the swivel joint 19. The water outflow can also be increased or increased quickly by using the valve on the valved spout 6. Furthermore, multiple units of the present invention can be installed in several water return jets of the pool to regulate the overall temperature of the pool more efficiently. In other embodiments, the present invention may comprise a plurality of temperature sensors and a controller that help control the overall temperature of the pool water. The valved drain 11 and the valved spout 6 may each also include electrically actuated valves. Each of the electrically actuated valves can be communicably coupled to the controller so that the electrically actuated valves can be selectively engaged to open or close the corresponding valve. The plurality of temperature sensors can also be distributed about the pool and within the present invention to monitor the water temperature across the system. The plurality of temperature sensors can be electronically connected to the controller. Thus, the controller can receive signals corresponding to the temperature measurements from the plurality of temperature sensors and activate the electrically actuated valves accordingly. Furthermore, a user interface may be provided to help the user to remotely control the present invention.

Although the invention has been explained in relation to its preferred embodiment, it is to be understood that many other possible modifications and variations can be made without departing from the spirit and scope of the invention.

What is claimed is:

1. A thermal regulation apparatus for pool water comprising:
a water-jet adapter;
a tee tubing connector;
a valved spout;
a valved drain;
an extension pipe;
the tee tubing connector comprising a connector inlet, a first connector outlet, and a second connector outlet;
the extension pipe comprising a first pipe end and a second pipe end;
the water-jet adapter being in fluid communication with the connector inlet;
the first connector outlet being in fluid communication with the valved drain;
the second connector outlet being in fluid communication with the first pipe end; and,
the second pipe end being in fluid communication with the valved spout.

2. The thermal regulation apparatus for pool water as claimed in claim 1 comprising:
the valved spout comprising a spout body, a spout inlet, and a spout outlet;
the spout inlet being in fluid communication with the spout outlet through the spout body;
the spout inlet being hermetically connected to the second pipe end; and, the spout outlet being oriented at a dispensing angle with the spout inlet.

3. The thermal regulation apparatus for pool water as claimed in claim 2, wherein the dispensing angle is an obtuse angle.

4. The thermal regulation apparatus for pool water as claimed in claim 1 comprising:
a swivel joint;
an aerating nozzle;
the valved spout comprising a spout body, a spout inlet, and a spout outlet;
the spout inlet being in fluid communication with the spout outlet through the spout body;
the spout inlet being hermetically connected to the second pipe end by the swivel joint;
the spout outlet being oriented at a dispensing angle with the spout inlet; and,
the aerating nozzle being hermetically connected to the spout outlet.

5. The thermal regulation apparatus for pool water as claimed in claim 4, wherein the dispensing angle is an obtuse angle.

6. The thermal regulation apparatus for pool water as claimed in claim 4, wherein the aerating nozzle is a venturi eductor.

7. The thermal regulation apparatus for pool water as claimed in claim 1 comprising:
the valved drain comprising a drain body, a drain inlet, and a drain outlet;
the drain inlet being in fluid communication with the drain outlet through the drain body;
the drain inlet being hermetically connected to the first connector outlet; and,
the drain outlet being oriented at a drainage angle with the drain inlet.

8. The thermal regulation apparatus for pool water as claimed in claim 7, wherein the drainage angle is a straight angle.

9. The thermal regulation apparatus for pool water as claimed in claim 1 comprising:
an inlet tubular joint;
the inlet tubular joint comprising a first joint end and a second joint end;
the water-jet adapter being threadably engaged to the first joint end; and
the second joint end being threadably engaged to the connector inlet.

10. The thermal regulation apparatus for pool water as claimed in claim 1 comprising:
an outlet tubular joint;
the outlet tubular joint comprising a third joint end and a fourth joint end;
the second connector outlet being threadably engaged to the third joint end; and
the fourth joint end being threadably engaged to the first pipe end.

11. A thermal regulation apparatus for pool water comprising:
a water-jet adapter;
a tee tubing connector;
a valved spout;
a valved drain;
an extension pipe;
the tee tubing connector comprising a connector inlet, a first connector outlet, and a second connector outlet;
the valved spout comprising a spout body, a spout inlet, and a spout outlet;
the extension pipe comprising a first pipe end and a second pipe end;
the water-jet adapter being in fluid communication with the connector inlet;
the first connector outlet being in fluid communication with the valved drain;
the second connector outlet being in fluid communication with the first pipe end;
the second pipe end being in fluid communication with the valved spout;
the spout inlet being in fluid communication with the spout outlet through the spout body;
the spout inlet being hermetically connected to the second pipe end; and,
the spout outlet being oriented at a dispensing angle with the spout inlet.

12. The thermal regulation apparatus for pool water as claimed in claim 11, wherein the dispensing angle is an obtuse angle.

13. The thermal regulation apparatus for pool water as claimed in claim 11 comprising:
the valved drain comprising a drain body, a drain inlet, and a drain outlet;
the drain inlet being in fluid communication with the drain outlet through the drain body;
the drain inlet being hermetically connected to the first connector outlet;
the drain outlet being oriented at a drainage angle with the drain inlet; and,
the drainage angle being a straight angle.

14. The thermal regulation apparatus for pool water as claimed in claim 11 comprising:
an inlet tubular joint;
an outlet tubular joint;
the inlet tubular joint comprising a first joint end and a second joint end;
the outlet tubular joint comprising a third joint end and a fourth joint end;
the water-jet adapter being threadably engaged to the first joint end;
the second joint end being threadably engaged to the connector inlet;
the second connector outlet being threadably engaged to the third joint end; and
the fourth joint end being threadably engaged to the first pipe end.

15. A thermal regulation apparatus for pool water comprising:
a water-jet adapter;
a tee tubing connector;
a valved spout;
a valved drain;
an extension pipe;
a swivel joint;
an aerating nozzle;
the tee tubing connector comprising a connector inlet, a first connector outlet, and a second connector outlet;
the valved spout comprising a spout body, a spout inlet, and a spout outlet;
the extension pipe comprising a first pipe end and a second pipe end;
the water-jet adapter being in fluid communication with the connector inlet;
the first connector outlet being in fluid communication with the valved drain;
the second connector outlet being in fluid communication with the first pipe end;
the second pipe end being in fluid communication with the valved spout;
the spout inlet being in fluid communication with the spout outlet through the spout body;
the spout inlet being hermetically connected to the second pipe end by the swivel joint;
the spout outlet being oriented at a dispensing angle with the spout inlet; and,
the aerating nozzle being hermetically connected to the spout outlet.

16. The thermal regulation apparatus for pool water as claimed in claim 15, wherein the dispensing angle is an obtuse angle.

17. The thermal regulation apparatus for pool water as claimed in claim 15, wherein the aerating nozzle is a venturi eductor.

18. The thermal regulation apparatus for pool water as claimed in claim 15 comprising:
the valved drain comprising a drain body, a drain inlet, and a drain outlet;
the drain inlet being in fluid communication with the drain outlet through the drain body;
the drain inlet being hermetically connected to the first connector outlet;
the drain outlet being oriented at a drainage angle with the drain inlet; and,
the drainage angle being a straight angle.

19. The thermal regulation apparatus for pool water as claimed in claim 15 comprising:
an inlet tubular joint;
an outlet tubular joint;
the inlet tubular joint comprising a first joint end and a second joint end;
the outlet tubular joint comprising a third joint end and a fourth joint end;
the water-jet adapter being threadably engaged to the first joint end;
the second joint end being threadably engaged to the connector inlet;
the second connector outlet being threadably engaged to the third joint end; and
the fourth joint end being threadably engaged to the first pipe end.
